(19) United States
(12) Patent Application Publication
(10) Pub. No.: US 2026/0027516 A1
(43) Pub. Date: Jan. 29, 2026

(54) A CARBON CAPTURE PLANT

(71) Applicant: AKER CARBON CAPTURE NORWAY AS, Lysaker (NO)

(72) Inventor: Rayane HOBALLAH, Oslo (NO)

(21) Appl. No.: 18/877,310

(22) PCT Filed: Jun. 30, 2023
(86) PCT No.: PCT/EP2023/068014

§ 371 Date: Dec. 20, 2024

(30) Foreign Application Priority Data
Jul. 6, 2022 (NO) 20220777

(51) Int. Cl. B01D 53/62; B01D 53/00; B01D 53/04; B01D 53/96

(52) U.S. Cl. CPC B01D 53/62; B01D 53/005; B01D 53/0423; B01D 53/96; B01D 2257/504; B01D 2258/0283

(57) ABSTRACT

The disclosure concerns a carbon capture plant comprising: an emission source providing a source flow of a fluid containing CO₂; a carbon capture and conditioning arrangement configured to capture CO₂ from the source flow fluid and prepare the captured CO₂ for transport and/or storage; and a direct air carbon capture arrangement configured to capture CO₂ from ambient air and provide an outgoing flow enriched in CO₂, wherein the carbon capture plant is configured to integrate the carbon capture and conditioning arrangement and the direct air carbon capture arrangement. The disclosure also concerns a method for operating the carbon capture plant.

### TECHNICAL FIELD

This disclosure relates to a carbon capture plant. In particular, the disclosure relates to an integrated carbon capture plant comprising a point source carbon capture and conditioning arrangement as well as a direct air carbon capture arrangement.

### BACKGROUND

Carbon capture, such as carbon capture and storage (CCS) and carbon capture utilization (CCU), is an important field of technology for reducing the release and concentration of carbon dioxide (CO₂) to/in the atmosphere. Carbon capture may involve separation of CO₂ from a gas mixture emission source or from ambient air followed by purification, dehydration and compression or liquefaction of the separated CO₂. The resulting CO₂ may be transported in pipelines or by ships for storage in deep geological formations (sequestration) or used to produce new materials.

As noted in Wikipedia under Carbon capture and storage: “Capturing CO₂ is most cost-effective at point sources, such as large carbon-based energy facilities, industries with major CO₂ emissions (e.g. cement production, steelmaking), natural gas processing, synthetic fuel plants and fossil fuel-based hydrogen production plants. Extracting CO₂ from air is possible, although the lower concentration of CO₂ in air compared to combustion sources complicates the engineering and makes the process therefore more expensive.”

There is a general need for more cost-and energy-efficient carbon capture plants.

### SUMMARY

An object of this disclosure is to provide a carbon capture plant and method that combines point source carbon capture and direct air carbon capture (DAC) in an integrated plant that reduces the cost of direct air capture compared with a conventional standalone direct air capture plant. This object is achieved by the plant and method defined by the technical features contained in the independent claims. The dependent claims contain advantageous embodiments, further developments and variants of the disclosure.

The disclosure concerns a carbon capture plant comprising an emission source providing a source flow of a fluid containing CO₂; a carbon capture and conditioning arrangement configured to capture CO₂ from the source flow fluid and prepare the captured CO₂ for transport and/or storage; and a direct air carbon capture arrangement configured to capture CO₂ from ambient air and provide an outgoing flow enriched in CO₂. The carbon capture plant is configured to integrate the carbon capture and conditioning arrangement and the direct air carbon capture arrangement.

In embodiments, the carbon capture plant comprises at least one of the following:
i) a fan arrangement configured to generate a flow of air forming an incoming flow to the direct air carbon capture arrangement, wherein the fan arrangement is provided with a fan heat exchanger arranged to cool, by means of the air flow, a flow of a fluid that transfers excess heat away from the carbon capture and conditioning arrangement during operation of the plant; and/or
ii) a heat exchanger arrangement configured to transfer excess heat from the carbon capture and conditioning arrangement during operation of the plant to a regeneration unit of the direct air carbon capture arrangement; and/or
iii) a flow line configured to feed water from the carbon capture and conditioning arrangement to the direct air carbon capture arrangement during operation of the plant, wherein the water is generated by condensation when cooling the source flow in the carbon capture and conditioning arrangement; and/or
iv) a flow line configured to feed the CO₂-enriched outgoing flow from the direct air carbon capture arrangement to the carbon capture and conditioning arrangement, wherein the carbon capture and conditioning arrangement is configured to capture and/or prepare also the CO₂ originating from the direct air capture arrangement.

The emission source providing the source flow typically forms what is commonly referred to as a point source, and the carbon capture and conditioning arrangement is thus configured to capture CO₂ from this point source. The carbon capture and conditioning arrangement may be adapted for post-combustion, pre-combustion or oxy-combustion and may include various technologies for capture and purification, such as absorption, adsorption, membrane, cryogenic or any combination of the previous.

The carbon capture and conditioning arrangement may be seen as a single integrated process or as a combination of processes with e.g. capture, purification and conditioning parts. The conditioning part may include dewatering units, compressors, liquefaction facility, and similar equipment.

The carbon capture plant may in addition comprise CO₂ tanks, loading stations, CO₂ pipeline, etc.

By integrating a direct air carbon capture (DAC) arrangement with a point source carbon capture and conditioning arrangement as specified above, it becomes possible to let the DAC make use of facilities, auxiliaries and specific equipment forming part of the point-source capture plant, i.e. facilities etc. that already may exist if the DAC is integrated with an existing point-source plant. In any case, the cost of the otherwise expensive direct air capture CO₂ removal unit is substantially reduced. Besides the reduced capital costs for building the DAC unit, there are operation advantages associated with such an integrated plant since e.g. waste heat and waste water from the point source unit can be used as sources in the DAC unit and since the air flow needed for the DAC can be used also for cooling a flow recirculated from the point-source capture plant. Exactly how to integrate the two processes depends e.g. on the capture technologies. In many applications it is possible and advantageous to combine two or more of the integration alternatives given above; in certain applications all four alternatives may be combined.

The DAC may typically be based on absorption or adsorption but may also be based on membrane technology or electrochemical air separation. Heat is generally needed in absorption and adsorption processes for releasing CO₂, i.e. for regenerating an active liquid or solid material loaded with CO₂.

The fan arrangement specified above is useful in most applications since most DACs require a forced flow of air and since most point source carbon capture and conditioning arrangements generate excess heat during operation. Because the fan arrangement is used both for providing the air flow to the DAC and for cooling of (at least parts of) the carbon capture and conditioning arrangement, it dispenses with the need for a separate DAC fan while also reduces or eliminates the need of additional cooling equipment for the point source carbon capture and conditioning arrangement. In addition, this heat may not be wasted as in most conventional point source carbon capture and conditioning arrangements; instead the excess heat may heat (some of) the air fed to the DAC, which may be useful depending on the type of DAC used. But even if the heat is transferred to the CO₂ depleted air flow downstream the DAC and then simply released to the surroundings, there is still an advantage since cooling is provided by an air flow that is necessary to generate anyway.

In an embodiment, the fan heat exchanger is arranged downstream the direct air carbon capture arrangement so that the air flow passes the direct air carbon capture arrangement before reaching the fan heat exchanger during operation of the carbon capture plant.

The heat exchanger arrangement specified above, i.e. the arrangement where excess heat is transferred to a regeneration unit of the direct air carbon capture arrangement, is useful for dispensing with the need for providing a separate regeneration heat source for the DAC. This is a complement or alternative to the fan arrangement described above, and in this case the excess heat is not transferred to the air flow fed to the DAC but to the regeneration unit of the DAC. This can be done in various ways and may involve a plurality of heat exchangers and heat-carrying medium. Also in this case the excess heat generated by the point source carbon capture and conditioning arrangement is utilized as a heat source.

The water feed line specified above, where water generated by cooling and condensation in the carbon capture and conditioning arrangement is fed to the direct air carbon capture arrangement, provides a water source for the DAC. This is particularly useful when the DAC requires large amounts of water, such as when the DAC includes a moisture swing adsorption unit. This dispenses with the need to provide for a separate water source for the DAC. Since the water fed to the DAC typically should be warm or even be in the form of steam or vapour, this water feed line is preferably combined with the heat exchanger arrangement described above so that the water to be fed to the DAC is heated by the excess heat before being fed further to the DAC. The water may be subject to purification or other treatment in e.g. a liquid effluent treatment facility on its way from the carbon capture and conditioning arrangement towards the direct air carbon capture arrangement. Preferably, such a treatment facility is arranged upstream of the heat exchanger.

The CO₂ feed line specified above, where the CO₂-enriched outgoing flow from the DAC is fed to the carbon capture and conditioning arrangement, is useful as the same equipment can handle the CO₂ from both the point source and the DAC; there is thus no need to provide a separate conditioning arrangement for the DAC, which typically is required for conventional standalone DAC plants. The CO₂-enriched outgoing flow from the DAC may be fed to different points in the carbon capture and conditioning arrangement depending on the composition of the outgoing CO₂-flow and the design of the carbon capture and conditioning arrangement. For instance, a DAC based on solvent, membrane or electrochemistry may produce a stream of almost pure CO₂ containing only minor amounts of e.g. water, nitrogen and oxygen. Such a flow may be fed to e.g. a dewatering unit in the conditioning arrangement. On the other hand, a DAC based on adsorption may produce a stream mostly composed of air or another carrier gas or even vacuum with a low partial pressure of CO₂. Such a flow may be fed to the carbon capture and conditioning arrangement upstream thereof, i.e. it may be mixed with the source flow from the emission source/point source. Other variants for feeding CO₂-enriched outgoing flow from the DAC to the carbon capture and conditioning arrangement are also possible.

In an embodiment where the plant comprises the fan arrangement, the flow of the fluid that transfers excess heat away from the carbon capture and conditioning arrangement is arranged to recirculate in a closed loop that passes one or more heat exchanging units arranged in the carbon capture and conditioning arrangement.

In an embodiment where the plant comprises the heat exchanger arrangement, the carbon capture and conditioning arrangement comprises a direct contact cooler arranged to cool the source flow by means of a flow of a coolant liquid, wherein at least a first portion of the flow of coolant liquid leaving the direct contact cooler is arranged to flow to the heat exchanger arrangement so as to transfer heat directly or indirectly to the regeneration unit of the direct air carbon capture arrangement.

In an embodiment, the heat exchanger arrangement comprises a heat pump arranged to further increase the temperature of the heat delivered to the regeneration unit of the direct air carbon capture arrangement.

In an embodiment where the plant comprises the water flow line, the carbon capture and conditioning arrangement comprises a direct contact cooler arranged to cool the source flow by means of a flow of water, wherein at least a second portion of the flow of water leaving the direct contact cooler is arranged to be fed to the water flow line towards the direct air carbon capture arrangement.

In an embodiment, the water flow line is arranged to direct the water to a liquid effluent treatment facility for water purification before feeding the water further to the direct air carbon capture arrangement.

In an embodiment, the water flow line is arranged to direct the water to a heat exchanger arrangement for increasing its temperature before feeding the water further to the direct air carbon capture arrangement.

In an embodiment where the plant comprises the heat exchanger arrangement and the water flow line, the coolant liquid for cooling the source flow in the direct contact cooler is a flow of water, wherein the water flow line is arranged so that water flowing along the water flow line passes through the liquid effluent treatment facility before passing through the heat exchanger arrangement, wherein heat is transferred in the heat exchanger arrangement from the first portion of the flow of coolant liquid leaving the direct contact cooler to the water flowing in the water flow line.

In an embodiment, the direct air capture arrangement comprises a moisture swing adsorption unit. However, as mentioned above, the DAC may comprise other types of carbon capture units.

The disclosure also concerns a method for operating a carbon capture plant, the method comprising:
providing a source flow of a fluid containing CO₂;
capturing CO₂ from the source flow fluid and preparing the captured CO₂ for transport and/or storage in a carbon capture and conditioning arrangement;
capturing CO₂ from ambient air and providing an outgoing flow enriched in CO₂ in a direct air carbon capture arrangement; and
integrating the operation of the carbon capture and conditioning arrangement and the direct air carbon capture arrangement.

In an embodiment the method comprises:
generating a flow of air by means of a fan arrangement so as to form an incoming flow to the direct air carbon capture arrangement;
transferring excess heat away from the carbon capture and conditioning arrangement by means of a flow of a fluid; and
cooling, by means of the air flow, said fluid flow in a fan heat exchanger arranged in the fan arrangement.

In an embodiment the method comprises:
transferring excess heat from the carbon capture and conditioning arrangement to a regeneration unit of the direct air carbon capture arrangement using a heat exchanger arrangement.

In an embodiment the method comprises:
generating condensed water by cooling the source flow in the carbon capture and conditioning arrangement;
feeding the condensed water from the carbon capture and conditioning arrangement to the direct air carbon capture arrangement in a water flow line.

In an embodiment the method comprises:
feeding the CO₂-enriched outgoing flow from the direct air carbon capture arrangement to the carbon capture and conditioning arrangement in a CO₂ flow line;
capturing and/or preparing also the CO₂ originating from the direct air capture arrangement in the carbon capture and conditioning arrangement.

### BRIEF DESCRIPTION OF DRAWINGS

In the description given below reference is made to the following figure, in which:

FIG. 1 shows a schematic overview of an embodiment of the carbon capture plant according to this disclosure.

FIG. 2 shows a more detailed schematic view of some parts of the embodiment of FIG. 1.

FIG. 3 shows a more detailed schematic view of some other parts of the embodiment of FIG. 1.

FIG. 4 shows an example of a combination of a fan arrangement and a direct air carbon capture arrangement where an air flow passes through a left bed that forms a CO2 capture bed and where a right bed forms a CO2 regeneration bed.

FIG. 5 shows the example of FIG. 4 where the air flow has been redirected so that the right bed forms a capture bed and the left bed forms a regeneration bed.

FIG. 6 shows another example of a combination of a fan arrangement and a direct air carbon capture arrangement where the left bed forms a capture bed, where the right bed forms regeneration bed and where captured CO2 continuously is transferred to the right bed.

### DETAILED DESCRIPTION

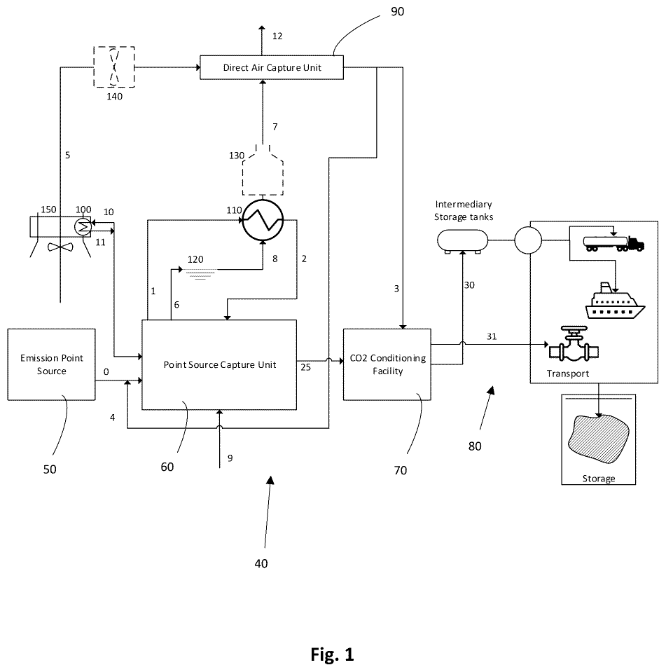

FIGS. 1-3 show an embodiment of the carbon capture plant 40 according to this disclosure. As shown in FIG. 1, main parts of the plant 40 include an emission point source 50 providing a source flow 0 of a fluid containing CO₂, a carbon capture and conditioning arrangement, here illustrated as forming a capture unit 60 configured to capture CO₂ from the source flow fluid 0 and a conditioning unit/facility 70 configured to prepare the captured CO₂ for transport and/or storage in a transport and storage facility 80. The plant 40 further comprises a direct air carbon capture arrangement 90 (DAC) configured to capture CO₂ from ambient air, via incoming air flow 5, and provide an outgoing flow 3, 4 enriched in CO₂. The two outgoing flows 3 and 4 are intended to indicate two alternative flows that may be fed to different points in the carbon capture and conditioning arrangement 60, 70 depending on the composition of the CO₂, which in turn depends on the design of the DAC, and the design of the carbon capture and conditioning arrangement 60, 70.

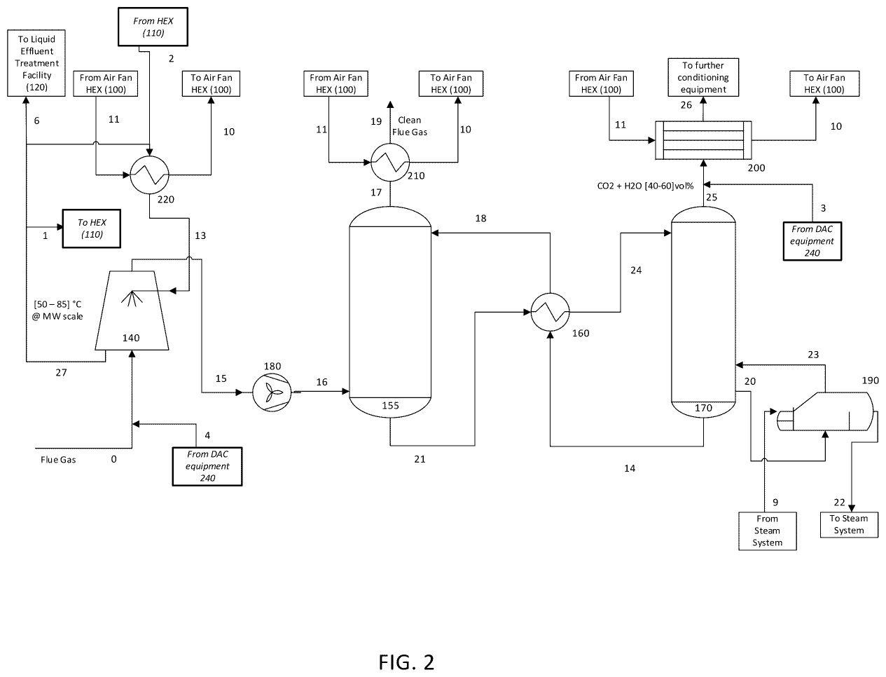

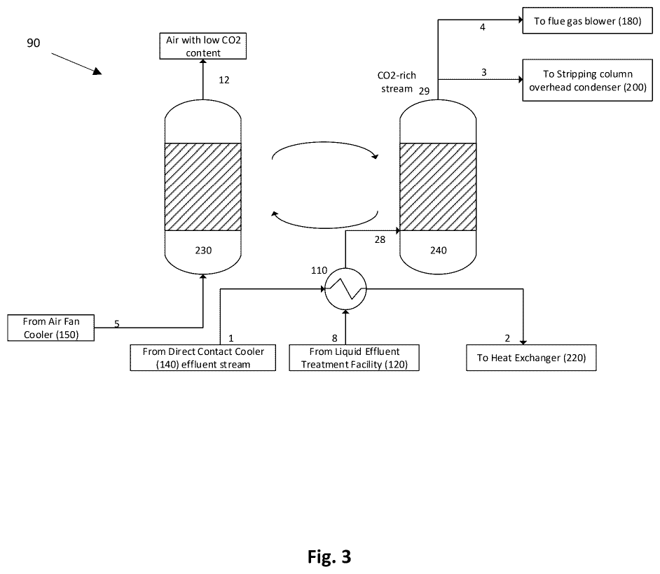

FIG. 2 focuses on the point source capture unit 60, which in this example is based on capturing CO₂ in a solvent containing amines. FIG. 3 focuses on the DAC 90, which in this example comprises a moisture swing adsorption unit that produces an outgoing flow 3 with a relatively low concentration of CO₂, and this flow 3 is mixed with the source flow 0 upstream of the point source capture unit 60.

The moisture swing adsorption unit of the DAC 90 requires relatively large amounts of hot water/steam/vapour for regeneration and a water flow line 6, 120, 8, 7 is arranged to supply water to the DAC 90 from the point source capture unit 60. This water is generated by condensation when cooling the source flow 0 in a direct contact cooler 140, see FIG. 2. The water is purified (and cooled) in a liquid (water) effluent treatment facility 120 and heated in heat exchange arrangement 110 before being fed to the DAC 90. A portion of the water 27 leaving the cooler 140 (see FIG. 2) forms a flow 1, 2 used in heat exchanger arrangement 110 to heat the water to be fed to the DAC 90 (after it has been at least slightly cooled in the liquid effluent treatment facility 120).

A fan arrangement 150 provides the air flow 5, 12. The fan arrangement 150 is provided with a fan heat exchanger 100 arranged to cool, by means of the air flow 5, 12, a flow 10, 11 of a coolant that transfers excess heat away from the carbon capture and conditioning arrangement 60, 70 during operation of the plant 40. The coolant, i.e. the flow 10/11, is arranged to recirculate in a closed loop that passes one or more heat exchanging units 200, 210, 220 arranged in the carbon capture and conditioning arrangement 60, 70.

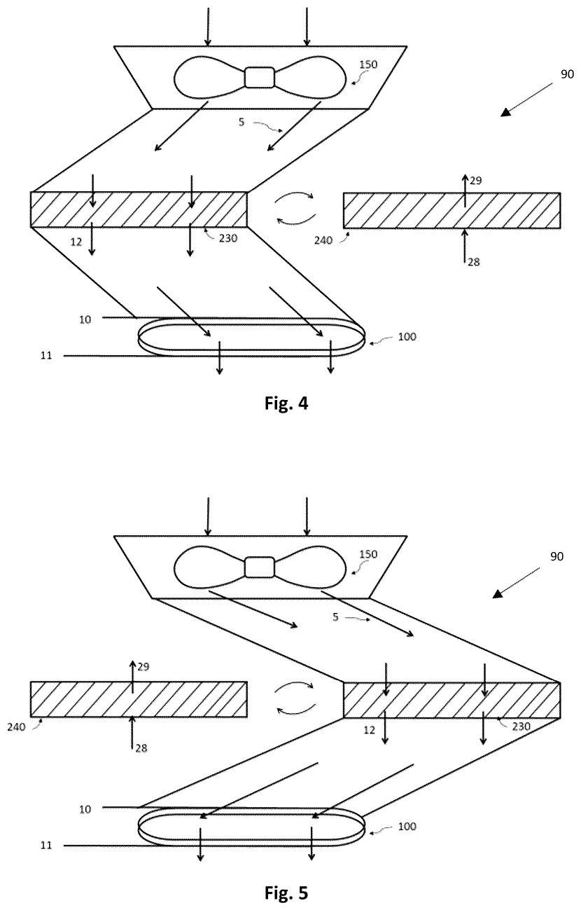

It may be said that the fan arrangement 150 comprises a fan, an air flow conduit, and the fan heat exchanger 100, where the fan heat exchanger 100 is arranged in, or at least in thermal communication with, the air flow conduit. FIG. 1 provides only a schematic view of the fan arrangement 150 as it mainly is intended to indicate that the flow 10/11 is cooled by the same air flow that also is used for the DAC 90. In reality it is possible to arrange the fan arrangement 150 and the DAC 90 so as to form an integrated structure, and the fan heat exchanger 100 may be arranged in the air conduit downstream the DAC 90 as exemplified in FIGS. 4-6.

Excess heat from the carbon capture and conditioning arrangement 60, 70 is in this example thus transferred both to the incoming air flow 5 of the DAC 90 as well as to the water, flow 8/7, fed to the regeneration unit of the DAC 90. Further examples of the integration of the two processes are that the fan arrangement 150 provides both the air flow 5 to the DAC 90 as well as cooling of the carbon capture and conditioning arrangement 60, 70. A further integrating feature is that the CO₂-enriched outgoing flow 3, 4 from the DAC 90 can be handled by the carbon capture and conditioning arrangement 60, 70 that handles also the source flow 0. Dashed lines in FIG. 1 indicate equipment that typically is necessary in a standalone DAC plant, such as a separate fan for providing an incoming air flow and a heat and/or water source for supplying the DAC with heat/water.

Flows and equipment in FIGS. 1-3 are further described with the following tables:

FIG. 1

| Flow | |
|---|---|
| Number | Flow Function |
| 0 | Flue gas from emission point source (rich in CO2 [3-25]vol %) |
| 1 | Slip stream from Direct Contact Cooler 140 effluent >55° C. |
| 2 | Cool water stream <45° C. |
| 3 | High CO2 content (50-95 vol %) stream produced by the DAC process |
| 4 | Low CO2 content (<50 vol %) stream produced by the DAC process |
| 5 | Displaced air to DAC unit by air fan cooler's convection due to operation to cool |
| | stream 10 |
| 6 | Bleed from Direct Contact Cooler to water effluent treatment unit 120 |
| 7 | Hot water stream to DAC regeneration unit (Equipment 120 from FIG. 3) |
| 8 | Clean water from water effluent treatment facility 120 to heat exchanger 110 |
| 9 | Low pressure steam |
| 10 | Hot cooling fluid >55° C. |
| 11 | Cold cooling fluid <30° C. (likely need to pass through a chiller during summer |
| | days to reach such low temperature) |
| 12 | Low CO2 content air (<350 ppm) potentially with higher humidity than in flow 5 |
| 25 | CO2 + H2O [40-60] vol % |
| 30 | High purity CO2 (>95 vol %) in liquid form |
| 31 | High purity CO2 (>95 vol %) in dense form |
| Equipment | |
| Number | Equipment Function |
| 100 | Air fan coolers for the Point Source Capture Unit |
| 110 | Heat Exchanger to transfer heat from cooling fluid to the water sent to |
| | the DAC unit for regeneration. This could also be a mechanical heat |
| | pump in the case of the DAC technologies needing temperature >60° C. |
| | for regeneration |
| 120 | Water Effluent treatment station for stream purification (reverse |
| | osmosis for example) |
| 130 | Heat/steam generator for DAC regeneration: Obsolete under this |
| | configuration |
| 155 | Fans for air displacement to DAC contactor (equipment 100 FIG. 3) |

FIG. 2

| Flow | |
|---|---|
| Number | Flow Function |
| 0 | Flue gas from emission point source (rich in CO2 [3-25] vol %) |
| 1 | Slip stream from Direct Contact Cooler 140 effluent >55° C. |
| 2 | Cool water stream <45° C. |
| 3 | High CO2 content (50-95 vol %) stream produced by the DAC process |
| 4 | Low CO2 content (<50 vol %) stream produced by the DAC process |
| 6 | Bleed from Direct Contact Cooler to water effluent treatment unit 120 |
| 9 | Low pressure steam |
| 10 | Hot cooling fluid >55° C. |
| 11 | Cold cooling fluid <30° C. (likely need to pass through a chiller during summer |
| | days to reach such low temperature) |
| 13 | Direct Contact Cooler water inlet <35° C. |
| 14 | Hot amine Lean in CO2 |
| 15 | Polished flue gas to flue gas blower 180 |
| 16 | Polished flue gas with slightly higher pressure than in 15 (<2 bar) |
| 17 | Hot clean flue gas |
| 18 | Cooled amine lean in CO2 |
| 19 | Cooled clean flue gas <40 C. |
| 20 | Hot amine with intermediate CO2 loading |
| 21 | Rich in CO2 amine |
| 22 | Condensate to steam system |
| 23 | Hotter amine with intermediate CO2 loading |
| 24 | Hot amine rich in CO2 |
| 25 | CO2 + H2O [40-60] vol % |
| 26 | CO2 + H2O <40 vol % |
| 27 | Direct Contact Cooler effluent >55° C. |
| Equipment | |
| Number | Equipment Function |
| 140 | Direct Contact Cooler Cooling Tower |
| 150 | Absorber tower |
| 160 | Lean-rich amine heat exchanger |
| 170 | Stripping tower |
| 180 | Flue Gas Blower |
| 190 | Reboiler |
| 200 | Stripper condenser |
| 210 | Absorber overhead heat exchanger |
| 220 | Direct Contact Cooler wash water cooler heat exchanger |

FIG. 3

| Flow | |
|---|---|
| Number | Flow Function |
| 1 | Slip stream from Direct Contact Cooler effluent >55° C. |
| 2 | Cool water stream <45° C. |
| 3 | High CO2 content (50-95 vol %) stream produced by the DAC process |
| 4 | Low CO2 content (<50 vol %) stream produced by the DAC process |
| 5 | Displaced air to DAC unit by air fan cooler's convection |
| 8 | Clean water from water effluent treatment facility 120 to heat exchanger |
| | 110 |
| 12 | Low CO2 content air (<350 ppm) potentially with higher humidity than in |
| | flow 5 |
| 28 | Water Vapour for moisture swing or steam for thermal swing |
| 29 | Concentrated CO2 content stream produced by the DAC process (could |
| | be high or low based on the DAC technology) |
| Equipment | |
| Number | Equipment Function |
| 230 | Absorption/adsorption bed |
| 240 | Regeneration bed |

FIGS. 4-5 show an example of a combination or integration of the fan arrangement 150 and the direct air carbon capture arrangement 90. In FIG. 4 the air flow 5,12 passes through a left bed that forms the CO2 capture bed 230 whereas a right bed forms the CO2 regeneration bed 240. In this example the left bed saturates after some time and needs to be generated. FIG. 5 shows the situation when the incoming air flow 5 has been redirected so that the right bed forms the capture bed 230 and the left bed forms the regeneration bed 240 where flow 28/29 regenerates the bed. When the right bed starts to get close to saturation the incoming air flow 5 is switched back to the left bed and so on. The outgoing air flow 12 is continuously contacted with the fan heat exchanger 100 so as to cool the flow 10 and form the colder flow 11.

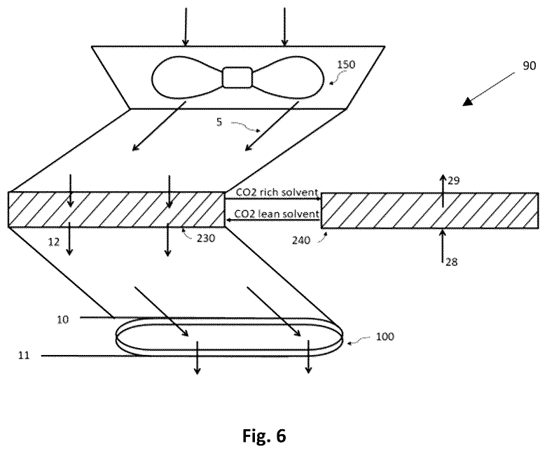

FIG. 6 shows another example of a combination of the fan arrangement 150 and the direct air carbon capture arrangement 90 where the left bed forms the capture bed 230, where the right bed forms the regeneration bed 240 and where captured CO2 continuously is transferred to the right bed by means of a solvent that recirculates between the capture and regeneration beds 230, 240. The conditions in the capture bed 230 are arranged so that the solvent absorbs CO2 and forms a rich solvent, and the conditions in the regeneration bed 240 are such that the solvent releases CO2 to the medium in flow 28 that then turns into flow 29. Typically, the temperature is considerably higher in the regeneration bed 240 than in the capture bed 230. Again, the outgoing air flow 12 is continuously contacted with the fan heat exchanger 100 so as to cool the flow 10 and form the colder flow 11.

The disclosure is not limited by the embodiments described above but can be modified in various ways within the scope of the claims. For instance, it is not necessary that the plant 40 makes use of all integration features described above. As an example, in some applications it may not be necessary to supply the DAC with water generated in the carbon capture and conditioning arrangement, it may be sufficient to let the carbon capture and conditioning arrangement function as a heat source for the DAC and/or use a common fan arrangement for supplying the air flow to the DAC and cooling of (parts of) the carbon capture and conditioning arrangement.

Moreover, the heat transfer from the carbon capture and conditioning arrangement to the DAC may be arranged in different ways, and each of the DAC and the carbon capture and conditioning arrangement may be based on other technologies than exemplified above.

1. A carbon capture plant comprising
an emission source providing a source flow of a fluid containing CO₂,
a carbon capture and conditioning arrangement configured to capture CO₂ from the source flow fluid and prepare the captured CO₂ for transport and/or storage,
a direct air carbon capture arrangement configured to capture CO₂ from ambient air and provide an outgoing flow enriched in CO₂,
wherein the carbon capture plant is configured to integrate the carbon capture and conditioning arrangement and the direct air carbon capture arrangement.

2. The carbon capture plant according to claim 1, wherein the carbon capture plant comprises a fan arrangement configured to generate a flow of air forming an incoming flow to the direct air carbon capture arrangement, wherein the fan arrangement is provided with a fan heat exchanger arranged to cool, by means of the air flow, a flow of a fluid that transfers excess heat away from the carbon capture and conditioning arrangement during operation of the plant.

3. The carbon capture plant according to claim 2, wherein the flow of the fluid that transfers excess heat away from the carbon capture and conditioning arrangement is arranged to recirculate in a closed loop that passes one or more heat exchanging units arranged in the carbon capture and conditioning arrangement.

4. The carbon capture plant according to claim 1, wherein the carbon capture plant comprises a heat exchanger arrangement configured to transfer excess heat from the carbon capture and conditioning arrangement during operation of the plant to a regeneration unit of the direct air carbon capture arrangement.

5. The carbon capture plant according to claim 4, wherein the carbon capture and conditioning arrangement comprises a direct contact cooler arranged to cool the source flow by means of a flow of a coolant liquid, typically water, wherein at least a first portion of the flow of coolant liquid leaving the direct contact cooler is arranged to flow to the heat exchanger arrangement so as to transfer heat directly or indirectly to the regeneration unit of the direct air carbon capture arrangement.

6. The carbon capture plant according to claim 4, wherein the heat exchanger arrangement comprises a heat pump arranged to further increase the temperature of the heat delivered to the regeneration unit of the direct air carbon capture arrangement.

7. The carbon capture plant according to claim 1, wherein the carbon capture plant comprises a flow line configured for feeding of water from the carbon capture and conditioning arrangement to the direct air carbon capture arrangement during operation of the plant, wherein the water is generated by condensation when cooling the source flow in the carbon capture and conditioning arrangement.

8. The carbon capture plant according to claim 7, wherein the carbon capture and conditioning arrangement comprises a direct contact cooler arranged to cool the source flow by means of a flow of water, wherein at least a second portion of the flow of water leaving the direct contact cooler is arranged to be fed to the water flow line towards the direct air carbon capture arrangement.

9. The carbon capture plant according to claim 7 er 8, wherein the water flow line is arranged to direct the water to a liquid effluent treatment facility for water purification before feeding the water further to the direct air carbon capture arrangement.

10. The carbon capture plant according to claim 7, wherein the water flow line is arranged to direct the water to a heat exchanger arrangement for increasing its temperature before feeding the water further to the direct air carbon capture arrangement.

11. The carbon capture plant according to claim 5, wherein the coolant liquid for cooling the source flow in the direct contact cooler is a flow of water, wherein the water flow line is arranged so that water flowing along the water flow line passes through the liquid effluent treatment facility before passing through the heat exchanger arrangement, wherein heat is transferred in the heat exchanger arrangement from the first portion of the flow of coolant liquid leaving the direct contact cooler to the water flowing in the water flow line.

12. The carbon capture plant according to claim 1, wherein the carbon capture plant comprises a flow line configured to feed the CO₂-enriched outgoing flow from the direct air carbon capture arrangement to the carbon capture and conditioning arrangement, wherein the carbon capture and conditioning arrangement is configured to capture and/or prepare also the CO₂ originating from the direct air capture arrangement.

13. The carbon capture plant according to claim 1, wherein the direct air capture arrangement comprises a moisture swing adsorption unit.

14. The carbon capture plant according to claim 2, wherein the fan heat exchanger is arranged downstream the direct air carbon capture arrangement so that the air flow passes the direct air carbon capture arrangement before reaching the fan heat exchanger during operation of the carbon capture plant.

15. Method for operating a carbon capture plant, the method comprising:
providing a source flow of a fluid containing CO₂;
capturing CO₂ from the source flow fluid and preparing the captured CO₂ for transport and/or storage in a carbon capture and conditioning arrangement,
capturing CO₂ from ambient air and providing an outgoing flow enriched in CO₂ in a direct air carbon capture arrangement; and
integrating the operation of the carbon capture and conditioning arrangement and the direct air carbon capture arrangement.

16. Method for operating a carbon capture plant according to claim 15, the method further comprising:
generating a flow of air by means of a fan arrangement so as to form an incoming flow to the direct air carbon capture arrangement;
transferring excess heat away from the carbon capture and conditioning arrangement by means of a flow of a fluid; and
cooling, by means of the air flow, said fluid flow in a fan heat exchanger arranged in the fan arrangement.

17. Method for operating a carbon capture plant according to claim 15, the method further comprising:
transferring excess heat from the carbon capture and conditioning arrangement to a regeneration unit of the direct air carbon capture arrangement using a heat exchanger arrangement.

18. Method for operating a carbon capture plant according to claim 15, the method further comprising:
generating condensed water by cooling the source flow in the carbon capture and conditioning arrangement;
feeding the condensed water from the carbon capture and conditioning arrangement to the direct air carbon capture arrangement in a water flow line.

19. Method for operating a carbon capture plant according to claim 15, the method further comprising:
feeding the CO₂-enriched outgoing flow from the direct air carbon capture arrangement to the carbon capture and conditioning arrangement in a CO₂ flow line;
capturing and/or preparing also the CO₂ originating from the direct air capture arrangement in the carbon capture and conditioning arrangement.
